(19) United States
(12) Patent Application Publication
(10) Pub. No.: US 2006/0024105 A1
(43) Pub. Date: Feb. 2, 2006

(54) Postcard making apparatus

(76) Inventor: Chao King, Fremont, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/903,602

(22) Filed: Jul. 30, 2004

(51) Int. Cl. B41J 11/44

(52) U.S. Cl. 400/76

(57) ABSTRACT

The present application relates to an apparatus for making postcards to allow a user to print postcards with images from, e.g., a digital camera.

### FIELD

The present invention relates to a postcard making apparatus for the creation and customization of various postcards.

### INTRODUCTION

Postcards are widely used for sending images from various locations and can include personalized messages. A person can choose cards with various pictures and can write messages on them for delivery to others around the world. Typical postcards and methods of making postcards, however, exhibit certain drawbacks. For example, a desirable postcard can be difficult to find from among the limited selection that a particular store carries. In addition, many postcards are available only in a preprinted form that typically excludes relevant people from the postcard. For example, preprinted postcards typically do not include an image of the person purchasing them.

With the advent and proliferation of digital cameras, people can take photos and can store the photo digitally onto a storage medium such as, for example, a memory card. The photo can be transferred to a computer or other storage device for further manipulation and/or viewing. It is desirable to create postcards that contain customized pictures and/or messages.

### SUMMARY

According to various embodiments, the present teachings can provide a postcard making apparatus, comprising an image data input/output device, a manual script input device, an image data storage device which stores at least one of the following: an image data input by the image data input/output device and a manual script data input by the manual script data input device, and a postcard printing device which prints an image and a manual script on a postcard generally corresponding to the image data and the manual script data stored in the storage device.

### BRIEF DESCRIPTION OF THE DRAWINGS

FIG. 1 illustrates a perspective view of a postcard making apparatus, according to certain embodiments;

FIG. 2 illustrates a block diagram of a postcard making apparatus, according to certain embodiments;

FIG. 3 illustrates a graphic display of a postcard making apparatus, according to certain embodiments; and

FIG. 4 illustrates a graphic display of a postcard making apparatus displaying a virtual postcard for writing text and/or manual scripts, according to certain embodiments.

### DESCRIPTION OF CERTAIN EMBODIMENTS

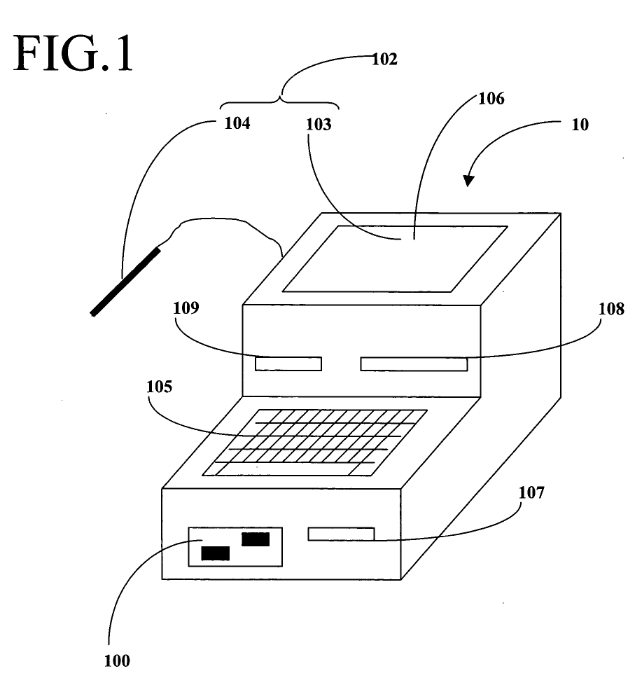

In certain embodiments, as illustrated by FIG. 1, a postcard making apparatus comprises an image data input/output device, a manual script input device, an image data storage device, and a postcard printing device. In certain embodiments, the image data input/output device can be a device that transfers image data between the image data storage device and a digital image data recording medium. In certain embodiments, the image data input/output device can be a device which only inputs image data. In certain embodiments, the image data input/output device can be a device which inputs and outputs image data. In certain embodiments, the image data input/output device can comprise a data reading device that facilitates the reading of image data that is stored, e.g., in a digital image data recording medium. Examples of a data reading device include, but are not limited to, digital memory card readers, compact disc (“CD”) readers, and/or digital versatile disc (“DVD”) readers.

In certain embodiments, the digital memory card can be used for storing various image data photographed by, e.g., a digital camera. The term “digital camera” includes, but is not limited to, various digital still cameras and various digital video cameras. In certain embodiments, the data reading device can transfer various image data to the image data storage device. Examples of digital memory cards include, but are not limited to, secure digital (“SD”) memory cards, Smart Media™ (SSFDC(solidstate floppydisk cards)), Memory Sticks™, Compact Flash™ cards, and the like.

In certain embodiments, the image data input/output device can comprise a scanning device such as, e.g., an image scanner or a digital camera. In certain embodiments, a photo studio for taking various photographs (e.g., a photo of the user along with various scenic backgrounds) can be placed near or with the postcard making apparatus.

In certain embodiments, the image data input/output device can comprise an image data receiving device that can be configured to receive various image data sent wirelessly, e.g., from a cell phone with a digital camera. Examples of wireless transmission consistent with certain embodiments of the invention include, but are not limited to, radio frequency (“RF”) and/or infrared (“IR”) transmission.

In certain embodiments, the manual script input device can facilitate input of certain manual script data. The term “manual script” as used herein refers to handwritten input such as, for example, letters for various languages, text, symbols, signatures, drawings, markings, and the like. In certain embodiments, the manual script input device can transfer various manual script data to the image data storage device.

In certain embodiments, manual script data and/or image data can be stored in an image data storage device such as, for example, a hard disk drive, memory card, random access memory (“RAM”), CD, and the like. In certain embodiments, image data storage device can facilitate the storage of various data including, but not limited to, image data input by the image data input/output device, and manual script data input by the manual script input device. In certain embodiments, the image data storage device can facilitate the storage of pre-existing image data (e.g., pictures of a popular landmark, etc.) In certain embodiments, pre-existing image data can be stored in the image data storage device before a user creates a postcard. In certain embodiments, if the user does not have a picture to include on the postcard, the user can choose a suitable picture or painting from among the various pre-existing image data.

In certain embodiments, manual script input device 102 can comprise an input screen 103 and a pen 104. In certain embodiments, input screen 103 can be configured to accept input from pen 104. In certain embodiments, input screen 103 can comprise a touch screen that receives input by physical contact. In certain embodiments, input screen 103 can comprise a screen that receives input without physical contact such as, for example, through the use of light, infrared radiation, radio-frequency, and the like. In certain embodiments, input screen 103 can facilitate display of various information to enable a user to communicate with postcard making apparatus 10. In certain embodiments, pen 104 can be configured to provide input to input screen 103 such as, for example, through physical contact and/or emission of light, radiation, radio-frequency, and the like. In certain embodiments, manual script data received by postcard making apparatus 10 can be transferred to the image data storage device.

In certain embodiments, certain image data input by image data input/output device 100 and/or manual script input device 102 can be deleted automatically by postcard making apparatus 10 after making a postcard. In certain embodiments, postcard making apparatus 10 can prompt a user to delete various data and/or copy various data to a digital image data recording medium such as, for example, a digital memory card, CD, and the like.

In certain embodiments, postcard making apparatus 10 can comprise a text data input device 105. In certain embodiments, text data input device 105 can facilitate input of text data such as, for example, input from a keyboard in various languages, into postcard making apparatus 10. In certain embodiments, text data input device 105 can comprise, e.g., a computer keyboard, touch-screen entry, and the like. In certain embodiments, text data input by text data input device 105 can be stored in the image data storage device. In certain embodiments, text data input by text data input device 105 can be stored in a text data storage device (not shown) that can be physically and/or virtually separate from the image data storage device. In certain embodiments, examples of the text data storage device can comprise a digital memory card, RAM, hard disk, CD, and the like.

In certain embodiments, postcard making apparatus 10 can comprise a postcard printing device (not shown). In certain embodiments, the postcard printing device can facilitate printing one or more images, certain text, and/or certain manual scripts on a postcard. In certain embodiments, examples of the postcard printing device include, but are not limited to, thermal printers (e.g., dye sublimation printers), ink jet printers, laser printers, and/or silver halide printers. In certain embodiments, the postcard printing device can print one or more images that generally correspond to certain image data input by image data input/output device 100 and/or stored in the image data storage device. In certain embodiments, the postcard printing device can print one or more manual scripts that generally correspond to certain manual script data input by the manual script input device and/or stored in the image data storage device. In certain embodiments, the postcard printing device can print one or more images that generally correspond to certain pre-existing image data stored in the image data storage device. In certain embodiments, the postcard printing device can print certain text that generally corresponds to certain text data input by text data input device 105 and/or stored in the image data storage device or the text data storage device.

In certain embodiments, postcards can comprise an image side and a reverse side. In certain embodiments, the image side of the postcard can comprise at least one image that generally corresponds to certain image data stored in the image data storage device. In certain embodiments, the postcard printing device can print certain manual scripts and/or text on the reverse side. In certain embodiments, the postcard printing device can print certain manual scripts and/or the text on the same side as the image side. In certain embodiments, the postcard printing device can print a plurality of generally similar postcards so that a user can keep one postcard while sending various postcards to other people.

In certain embodiments, postcard making apparatus 10 can comprise a plurality of postcard printing devices. For example, in certain embodiments, postcard making apparatus 10 can comprise a color printing device that can print, e.g., certain images, and a black and white printing device that can print, e.g., certain manual scripts and/or certain text.

In certain embodiments, postcard making apparatus 10 can comprise a display device 106. In certain embodiments, display device 106 can display one or more images that generally correspond to certain image data input by image data input/output device 100. In certain embodiments, display device 106 can display one or more images that generally correspond to certain pre-existing image data stored in the image data storage device. In certain embodiments, display device 106 can display certain manual scripts input by manual script input device 1 02 and/or certain text input by text data input device 105. In certain embodiments, display device 106 can display various information, such as, for example, instructions to help a user make a postcard and/or to operate postcard making apparatus 10.

In certain embodiments, display device 106 can comprise a liquid crystal display (“LCD”), a plasma panel display, and/or a cathode ray tube (“CRT”). In certain embodiments, both display device 106 and input screen 103 of manual script input device 102 can be incorporated into, e.g., a tablet touch screen. In certain embodiments, the tablet touch screen can comprise an order input device (not shown) that can facilitate the input of a postcard order by a user. For example, the order input device can comprise a graphical display that can prompt the user to, e.g., select certain products and/or services and pay for them by suitable payment methods, e.g., credit card, debit card, cash, and the like.

In certain embodiments, postcard making apparatus 10 can comprise an image data process device. In certain embodiments, image data process device can facilitate processing of certain image data, manual script data and/or text data, e.g., by adjusting certain image parameters. Examples of image parameters that can be adjusted include, but are not limited to, the size and/or layout of the image, the size and/or layout of the manual script, the size and/or layout of text, the color of the image, the color of the manual script, the color of the text, and/or the sharpness of the image, manual script, and/or text. In certain embodiments, image data to be processed can comprise various data such as, for example, certain image data input by image data input/output device 100, certain preexisting images stored in the image data storage device. In certain embodiments, image data process device 202 can comprise an integrated circuit (“IC”), a CPU, and/or various image processing software.

In certain embodiments, the image data input/output device 100 can comprise a postcard data recording device. In certain embodiments, the postcard data recording device can record various postcard data made by a user (e.g., certain image data, certain manual script data, and/or certain text data) onto a digital image data recording medium. Examples of digital image data recording media include, but are not limited to, various digital memory cards (e.g., Memory Stick™ cards, Secure Digital (“SD”) cards, Multi-Media Cards (“MMC”), Smart Cards, and/or Compact Flash cards), various compact-disc-based media (e.g., CD-R, CD-RW), various digital-video-disc-based media (e.g., DVD-R, DVD−RW, DVD+RW), and the like. In certain embodiments, postcard recording device can comprise a digital memory card recorder, such as, for example, a SD card recorder, a CD writer, and/or DVD writer.

In certain embodiments, various postcard data can be recorded onto a digital image data recording medium in a format that facilitates viewing of the image by a user. For example, in certain embodiments, postcard data can be recorded in a format that generally corresponds to the format of a user's digital camera, image viewing software, and/or CD/DVD player, so that the user can see the postcard image through the use of a user's digital camera, computer, and/or CD/DVD player.

In certain embodiments, postcard making apparatus 10 can comprise a receipt printer (not shown) that can print, for example, a sales receipt. In certain embodiments, the receipt printer can comprise a label printer to print, e.g., various labels and/or barcodes.

In certain embodiments, postcard making apparatus 10 can comprise a payment device 107 that can read certain payment information (e.g., a barcode on the product, a credit card magnetic strip, a radio-frequency, etc.) and can implement a payment procedure (e.g., calculate tax, etc.) In certain embodiments, payment device 107 can comprise a credit card reader. In certain embodiments, payment device 107 can comprise, e.g., a smart card reader (e.g., to read a card with an embedded chip), a radio-frequency (“RF”) device for wireless payment, a fingerprint reader, a voice recognition device, and the like.

In certain embodiments, a user's credit card can be inserted into postcard making apparatus 10 through payment device 107. In certain embodiments, insertion of user's credit card can activate postcard making apparatus 10 and thereby can start the postcard making process.

In certain embodiments, after the activation, a display device 106 such as an LCD can display a graphic display. In certain embodiments, graphic display can provide operating instructions to the user. In certain embodiments, input screen 103 on display device 106 can facilitate input of various manual scripts through the use of, e.g., a pen 104, such as, e.g., a touch pen, in combination with an input screen 103.

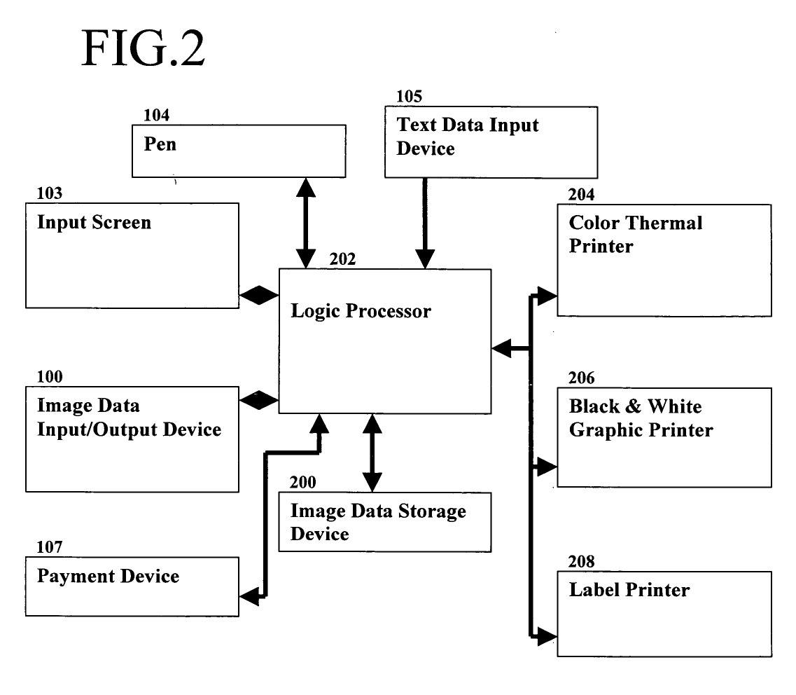

In certain embodiments, as illustrated in FIGS. 1-2, a digital image data recording medium such as, for example, a digital memory card can be inserted into one or more image data input/output devices 100, such as, for example, one or more digital memory card readers. In certain embodiments, insertion of a digital recording medium can facilitate transfer of certain data, including, but not limited to, certain image data stored on the digital image data recording medium, to postcard making apparatus 10. In certain embodiments, postcard making software configured to be executed by postcard making apparatus 10 can transfer certain data between the digital image data recording medium and a image data storage device 200 (see, e.g., FIG. 2) such as, for example, a memory unit. In certain embodiments, a message can be displayed on, e.g., display device 106 to inform the user to remove the digital image data recording medium from the one or more image data input/output devices 100.

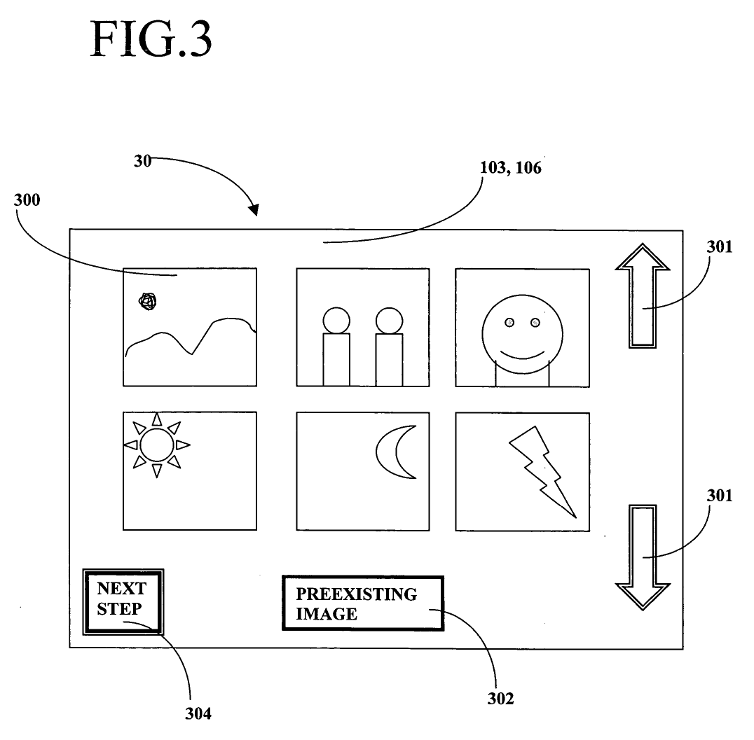

In certain embodiments, as illustrated in FIG. 3, a thumb nail of one or more images 300 can be displayed on display device 106. In certain embodiments, a digital image data recording medium such as, for example, a digital memory card can store one or more images which can be transferred to postcard making apparatus 10. In certain embodiments, graphic display 30 can comprise one or more scroll buttons 301 to facilitate a user's manipulation of one or more images 300. The user can touch one or more scroll buttons 301 on the touch screen 103 displayed on the display device 106 to scroll up and down or jump from one screen to another. In this manner, the user can select one or more desired images 300 that can be later printed on a postcard from among all of the images recorded in the digital image data recording medium. In certain embodiments, the user can select one or more images 300 by touching touch screen 103 in a location that corresponds to the one or more images 300 displayed on display device 106.

In certain embodiments, a user can select from among various preexisting images stored in an image data storage device 200 of postcard making apparatus 10 (see, e.g., FIG. 2). As illustrated in certain embodiments in FIG. 3, graphic display 30 can comprise a preexisting image button 302 that can facilitate a user's access to one or more preexisting images. In certain embodiments, a user can touch preexisting image button 302 to retrieve various preexisting images from image data storage device 200. In certain embodiments, the user can view one or more of the preexisting images on display device 106 and can select one or more images to be printed on a postcard by touching touch screen 103 in a location that corresponds to them on display device 106. In certain embodiments, one or more preexisting images can be printed on a postcard along with one or more images 300 retrieved from a digital image data recording medium, such as, for example, a digital memory card.

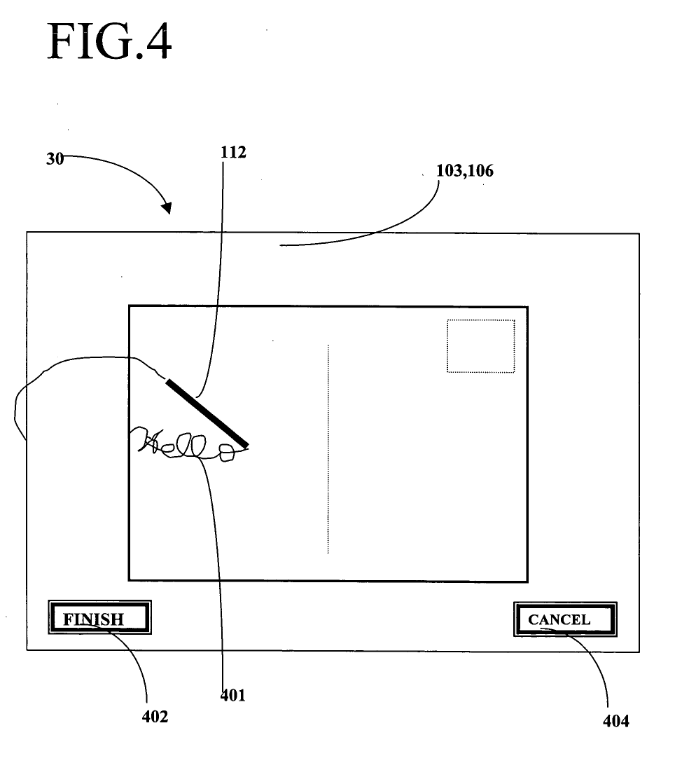

In certain embodiments, a user can start to input a message on a postcard by, e.g., touching touch screen 103 in a location that corresponds to a next step button 304 displayed on display device 106. In certain embodiments, as illustrated in FIG. 4, display device 106 can display a graphic of a reverse side of a typical postcard to facilitate input of, for example, a message and/or address.

In certain embodiments, a user can use pen 104 as part of manual script data input device 102 to facilitate input of certain manual scripts 401. In certain embodiments, the user can write directly on input screen 103 to create, for example, a message that the user desires to print on the postcard. In certain embodiments, input of various manual scripts 401 can be in one or more languages and/or can comprise symbols, drawings, and the like. In certain embodiments, postcard making apparatus 10 can receive various manual scripts 401 input by the user and can process the manual scripts as, for example, graphics files for later printing on the postcard. In certain embodiments, various manual scripts 401 input by user can be stored in image data storage device 200 (see, e.g., FIG. 2). In certain embodiments, the user can input certain messages by typing them on text data input device 105, such as, e.g., a keyboard (see, e.g., FIG. 1).

In certain embodiments, as illustrated in FIG. 4, a user can input information such as, for example, a recipient's name and/or address using pen 104 and/or text data input device 105. In certain embodiments, the user can delete an already input message and/or address and can re-enter them using pen 104 and/or text data input device 105. In certain embodiments, the user can touch a finish button 402 to facilitate completion of the postcard. For example, in certain embodiments, postcard making apparatus 10 can process certain data (e.g., image data, manual script data and/or text data) input by the user to prepare to print the completed postcard.

In certain embodiments, postcard making apparatus 10 can create a confirmation graphic that can display the completed postcard that is ready to print. In certain embodiments, one or both sides of the postcard can be displayed on display device 106. In certain embodiments, the postcard can be displayed in real size. In certain embodiments, postcard making apparatus 10 can prompt the user to confirm the appropriateness of the completed postcard. In certain embodiments, the user can cancel the postcard by touching a cancel button 404.

In certain embodiments, postcard making apparatus 10 can process various image data stored in image data storage device 200 by, e.g., resizing various image data to a pre-determined print size and formatting various image data to fit various postcard paper sizes. In certain embodiments, postcard making apparatus 10 can create an image file that can comprise one or more image data.

In certain embodiments, as illustrated in FIG. 2, postcard making apparatus 10 can send the image file to a color thermal printer 204. In certain embodiments, color thermal printer 204 can be internal to and/or external to postcard making apparatus 10. In certain embodiments, postcard making apparatus 10 can process various graphics data, for example, message data, name data, and/or address data, by resizing the various graphics data to the size of a postcard. In this manner, postcard making apparatus 10 can facilitate printing on a black & white graphic printer 206. In certain embodiments, black & white graphic printer 206 can be internal and/or external to postcard making apparatus 10.

In certain embodiments, postcard making apparatus 10 can generate a postcard by utilizing a plurality of printers. For example, in certain embodiments, color thermal printer 204 can print an image on one side of a postcard paper and then the partially-printed postcard can be flipped and received by black & white graphic printer 206 to print text and/or manual script data, e.g., message data and/or address data. In certain embodiments, image data and text/manual script data can be printed on the same side of the postcard. In certain embodiments, image data and text/manual script data can be printed by color thermal printer 204 and/or black & white graphic printer 206. In certain embodiments, a label printer 208 can print various labels including, but not limited to, a receipt of purchase.

In certain embodiments, as illustrated in FIG. 1, postcard making apparatus 10 can comprise a postcard outlet 108 and/or a receipt outlet 109. In certain embodiments, a printed postcard can be output from postcard outlet 108. In certain embodiments, a receipt can be output from receipt outlet 109. In certain embodiments, postcard making apparatus 10 can process certain ordering information such as, for example, forwarding credit card information to a bank. For example, postcard making apparatus 10 can be connected to an information network (e.g., the Internet or a company intranet) that can facilitate transfer of electronic data between various companies. In certain embodiments, postcard making apparatus 10 can store certain ordering information in memory unit 200.

In certain embodiments, image data input/output device 100 can comprise, e.g., a memory card writer to facilitate recording of various postcard data onto a recording media such as, for example, a digital memory card. In certain embodiments, image data input/output device 100 can record various postcard data including, but not limited to, image data, manual script data and/or text data onto a digital image data recording medium. In certain embodiments, image data input/output device 100 can record various postcard data in certain formats that correspond to various computer and/or digital camera formats to facilitate visualization and/or manipulation of the various postcard data on a computer and/or digital camera.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A postcard making apparatus comprising:
an image data input/output device;
a manual script input device;
an image data storage device which stores at least one of the following: an image data input by the image data input/output device and a manual script data input by the manual script data input device; and
a postcard printing device which prints an image and a manual script on a postcard generally corresponding to the image data and the manual script data stored in the image data storage device.

2. The postcard making apparatus of claim 1, wherein the image data input/output device comprises a data reading device which reads an image data included in a digital image data recording medium.

3. The postcard making apparatus of claim 2, wherein the digital image data recording medium comprises a digital memory card for storing an image data photographed by a digital camera and the data reading device is a digital memory card reader.

4. The postcard making apparatus of claim 1, wherein the postcard comprises an image side and a reverse side,
wherein the image side comprises at least one image generally corresponding to the image data stored in the image data storage device; and
wherein the postcard printing device prints the manual script on the reverse side of the postcard.

5. The postcard making apparatus of claim 1, further comprising a text data input device, wherein the postcard printing device prints a text data input by the text data input device.

6. The postcard making apparatus of claim 5, wherein the postcard comprises
an image side and a reverse side, and
wherein the image side comprises at least one image that generally corresponds to the image data stored in the image data storage device; and
wherein the postcard printing device prints the text data on the reverse side of the postcard.

7. The postcard making apparatus of claim 5, wherein the text data input device comprises a keyboard.

8. The postcard making apparatus of claim 1, wherein the manual script input device comprises a pen and an input screen, and
wherein the input screen is configured to accept input from the pen.

9. The postcard making apparatus of claim 8, wherein the input screen comprises a tablet touch screen.

10. The postcard making apparatus of claim 1, wherein the image data storage device comprises at least one preexisting image.

11. The postcard making apparatus of claim 1, wherein the postcard printing device comprises a thermal printer.

12. The postcard making apparatus of claim 1, wherein the postcard printing device comprises an ink jet printer.

13. The postcard making apparatus of claim 1, further comprising a receipt printer.

14. The postcard making apparatus of claim 1, further comprising a payment device.
